(19) United States
(12) Patent Application Publication
(10) Pub. No.: US 2010/0266730 A1
(43) Pub. Date: Oct. 21, 2010

(54) Edible Ice Cream Stick

(76) Inventors: Earl E. Patton, New Iberia, LA (US); Ernest Jerold Case, New Iberia, LA (US)

Correspondence Address: HARSHAW RESEARCH, INC., 210 W. TECUMSEH STREET, OTTAWA, KS, 66067, US

(21) Appl. No.: 12/539,680

(22) Filed: Aug. 12, 2009

Related U.S. Application Data
(60) Provisional application No. 61/171,106, filed on Apr. 21, 2009.

(51) Int. Cl. A23G 9/50; A23G 9/00

(52) U.S. Cl. 426/90; 426/100

(57) ABSTRACT

An edible ice cream stick includes a support member having a first inner layer that is generally rigid and constructed of a hard candy substance. The support member also includes a second intermediate layer having a cereal substance. A third outer layer is situated atop the second layer that consists a firm flavor coating that provides moisture protection to the second cereal layer.

### REFERENCE TO RELATED APPLICATIONS

This application is a non-provisional patent application that claims the priority of provisional application 61/171,106 entitled EDIBLE ICE CREAM STICK that was filed on Apr. 21, 2009.

### BACKGROUND OF THE INVENTION

This invention relates generally to frozen confection delivery devices and, more particularly, to an ice cream stick that is both edible and flavored. This invention would also apply to sticks that deliver ice cream bars, popsicles or other similar confections.

A favorite treat for both children and adults is an ice cream bar, popsicle, or other frozen confections typically delivered on a stick. These types of snack items are easy to eat in that a person may hold onto the stick while licking, sucking, or biting off portions of the frozen confection. Unfortunately, a wooden stick that must be disposed of is left over after the ice cream is completely eaten. This may be inconvenient or even disappointing that it, too, cannot be eaten in the manner of other types of stick candy.

Therefore, it would be desirable to have an edible ice cream stick that may be eaten after the ice cream that surrounds it is eaten. Further, it would be desirable to have an edible ice cream stick that has its own unique flavor when eaten.

### SUMMARY OF THE INVENTION

An edible ice cream stick according to one embodiment includes a support member having a first inner layer that is generally rigid and constructed of a hard candy substance. The support member also includes a second intermediate layer having a cereal substance. A third outer layer is situated about the second layer that consists a firm flavor coating that provides moisture protection to the second cereal layer.

Therefore, a general object of this invention is to provide an edible ice cream stick that may be eaten after the ice cream that surrounds it is eaten.

Another object of this invention is to provide an edible ice cream stick that has its own unique flavor when eaten.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an edible ice cream stick according to a preferred embodiment of the present invention;

FIG. 2a is a front view of the ice cream stick as in FIG. 1;

FIG. 2b is a sectional view taken along line 2b-2b of FIG. 2a;

FIG. 3 is a perspective view of an edible ice cream stick according to another embodiment of the present invention;

FIG. 4a is a front view of the ice cream stick as in FIG. 3; and

FIG. 4b is a sectional view taken along line 4b-4b of FIG. 4a.

### DESCRIPTION OF THE PREFERRED EMBODIMENT

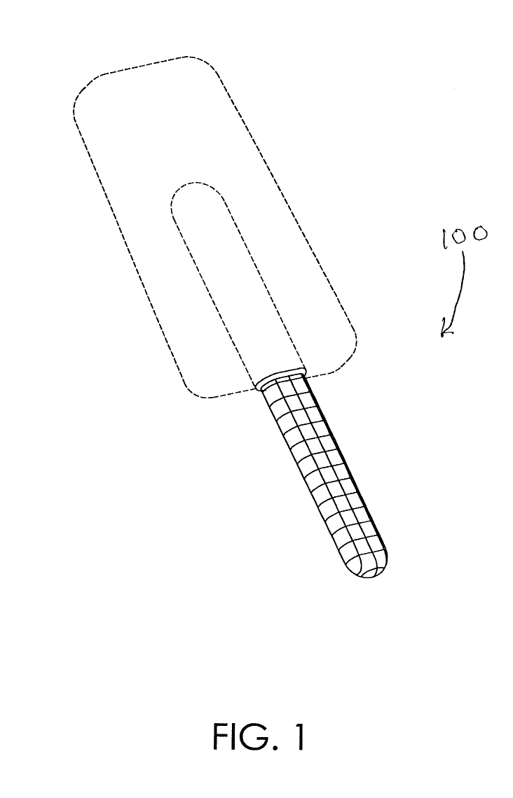

An edible ice cream stick according to a preferred embodiment of the present invention will be described with reference to FIGS. 1 to 4b of the accompanying drawings. More particularly, an edible ice cream stick 100 according to one embodiment includes an elongate support member 110 having first 120, second 130, and third 140 layers.

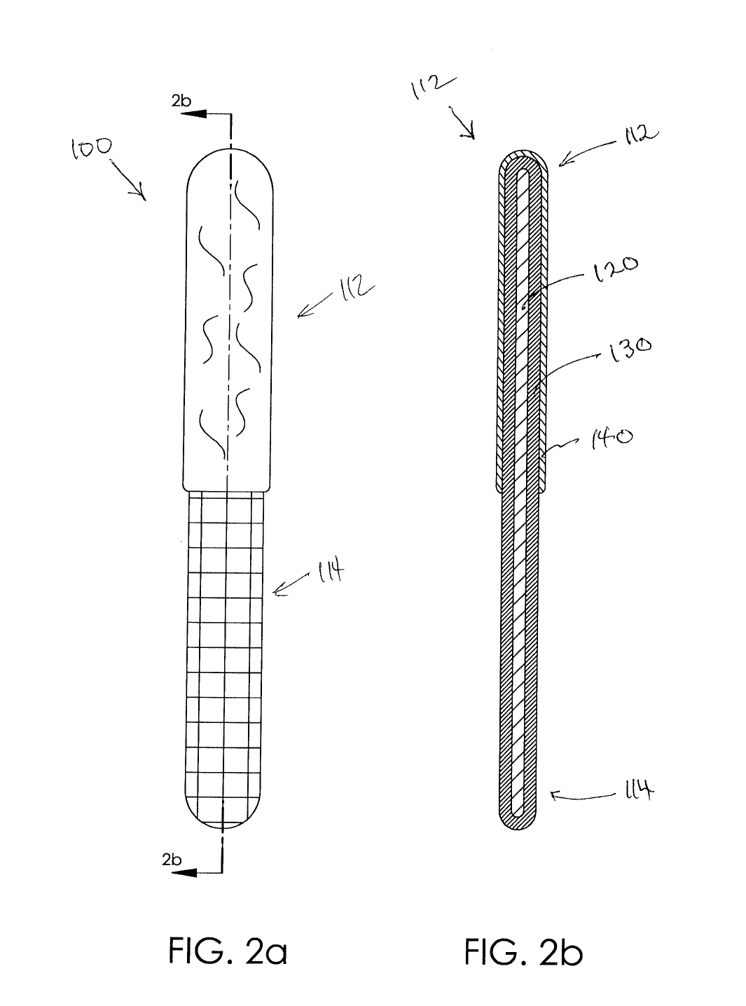

The first layer 120 of the support member 110 is configured in the shape of a thin plank so as to simulate the rigidity of a traditional ice cream stick (FIG. 2b). The first layer 120 may also be referred to herein as the innermost layer and may be constructed of a flavored candy. For example, the first layer 120 may be a hard candy confection having a peppermint flavor or some other flavor. The first layer is positioned immediately adjacent the support member, i.e. applied directly upon the support member.

The second layer 130 is positioned atop the first layer 120 so as to completely surround and envelop it (FIG. 2b). The second layer may also be referred to herein as the intermediate layer that is sandwiched between the first and third layers. Preferably, the second layer 130 is a cereal or graham cracker substance that provides a moderate level of additional stability to the support member 110.

The support member 110 includes an upper segment 112 and a lower segment 114. While the first 120 and second layers 130 extend over both the upper 112 and lower 114 segments, the third layer 140 is situated atop the second layer 130 only throughout the upper segment 112 (FIG. 2b). The third layer 140 may also be referred to herein as the outermost layer. The third layer 140 presents a generally hardened or rigid surface that is easily broken, say, by the teeth of a person eating a confection or that is dissolvable over time in a person's mouth. For example, the third layer 140 may be a thin coating of a flavor such as chocolate, cherry, or other flavor. The third layer 140 is able to keep the second/cereal layer 130 from becoming soggy too quickly by the ice cream that will be situated about the support member.

In use, a frozen confection such as ice cream or a popsicle may be situated to surround the support member as shown in dotted lines in FIG. 1. More particularly, the frozen confection surrounds the three layers upon the support member. A user may hold the lower segment 114 of the support member 110 with his fingers while eating the frozen confection. When the frozen confection is completely or partially eaten, the user may bite into the support member. More particularly, the user may bite through the second 130 and third 140 layers, removing them from the first layer 120. The first layer 120, which is preferably constituted of a hard flavored candy, may be licked or sucked on for more prolonged enjoyment.

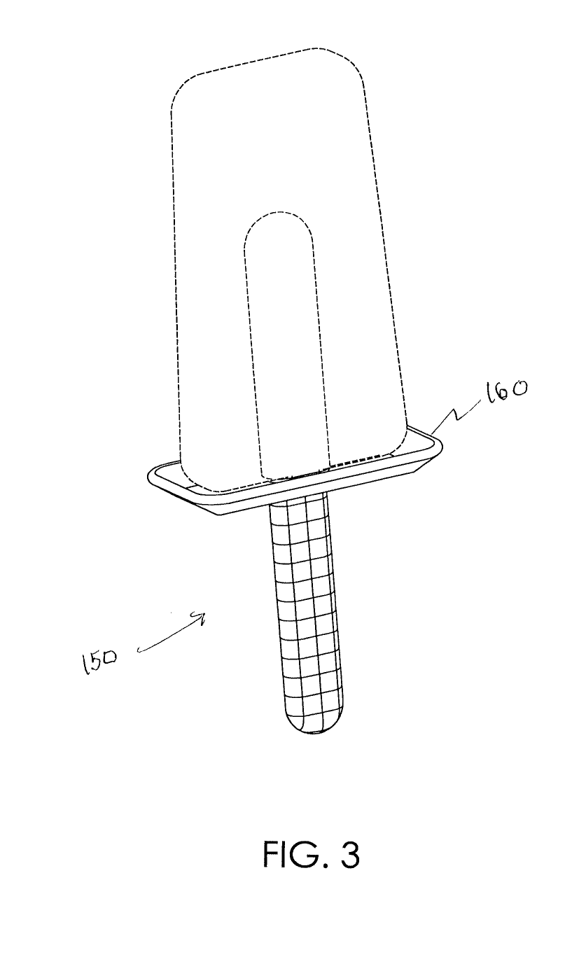

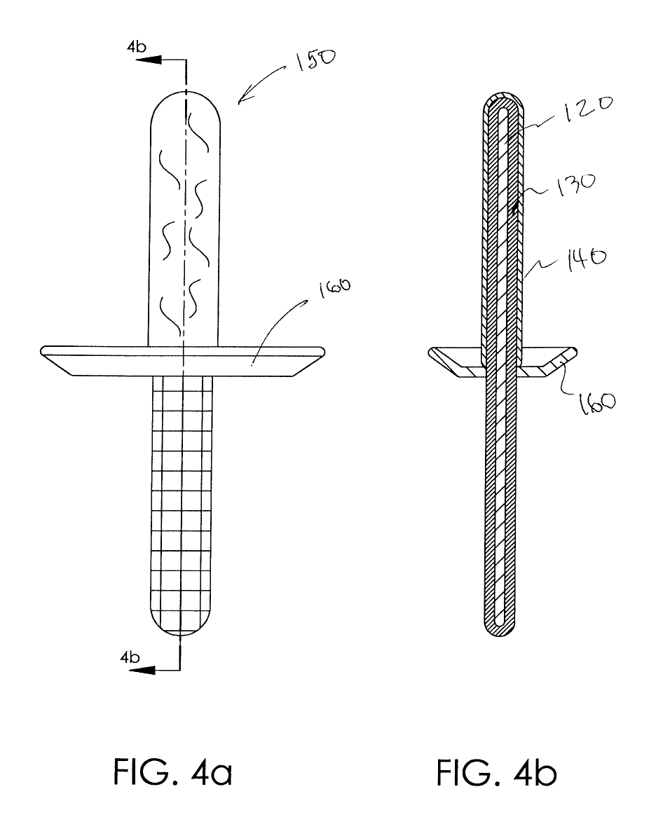

An edible ice cream stick 150 according to another embodiment of the present invention includes a construction substantially similar to the embodiment first described above except as specifically noted below. More particularly, the edible ice cream stick 150 shown in FIGS. 3 to 4b includes a drip guard 160 positioned at the juncture between the upper and lower segments of the support member. The drip guard 160 may have a generally concave configuration so as to collect any melted portions of the frozen confection. The drip guard includes a circumference that is greater than a circumference of the frozen confection.

1. An edible ice cream stick for use in holding a frozen confection to be consumed by a user, comprising:
an elongate support member having first, second, and third layers about which the frozen confection is supported;
wherein:
said first layer includes a hard candy positioned as an innermost layer;
said second layer includes one of a cereal or graham cracker material and is positioned atop said first layer;
said third layer is positioned atop said second layer and includes a rigid surface that is easily breakable by the pressure of a user's teeth;
wherein said second layer is sandwiched between said first and third layers and completely surrounds said first layer;
wherein:
said support member includes an upper segment and a lower segment;
said first and second layers extend over said upper and lower segments; and
said third layer is situated atop said second layer only over said upper segment.

2. The edible ice cream stick as in claim 1, wherein said support member is configured as a thin plank.

3. The edible ice cream stick as in claim 1, wherein said first layer includes a flavoring.

4. (canceled)

5. The edible ice cream stick as in claim 1, wherein said third layer is dissolvable in a user's mouth.

6. (canceled)

7. The edible ice cream stick as in claim 1, wherein said third layer inhibits said second layer from becoming soggy as the frozen confection melts.

8. The edible ice cream stick as in claim 1, wherein said third layer inhibits said second layer from becoming soggy as the frozen confection melts.

9. The edible ice cream stick as in claim 1, further comprising a drip guard positioned at a juncture between said upper and lower segments of said support member.

10. The edible ice cream stick as in claim 9, wherein said drip guard includes a concave configuration for collecting said frozen confection as it melts.

11. The edible ice cream stick as in claim 9, wherein said drip guard includes a circumference that is greater than a circumference of said frozen confection.

12. The edible ice cream stick as in claim 1, wherein said third layer includes a thin coating of a flavoring.
